(19) United States
(12) Patent Application Publication
(10) Pub. No.: US 2014/0059510 A1
(43) Pub. Date: Feb. 27, 2014

(54) Sizing Method for Stand-alone Photovoltaic System

(71) Applicant: Shin-Guang Chen, Taipei City (TW)

(72) Inventor: Shin-Guang Chen, Taipei City (TW)

(21) Appl. No.: 13/594,973

(22) Filed: Aug. 27, 2012

(51) Int. Cl. G06F 17/50

(52) U.S. Cl. 716/135

(57) ABSTRACT

A sizing method for a stand-alone photovoltaic system is provided. The stand-alone photovoltaic system includes photovoltaic plates and batteries. The sizing method includes steps of obtaining climate data in a site during a period of time, calculating Tcₘₐₓ/T by using the climate data where Tcₘₐₓ is maximal cycle time and T is battery charging time, identifying Tc*ₘₐₓ/T* where

$$\frac{T {c}_{max}^{*}}{{T}^{*}}$$

is a minimal value of Tcₘₐₓ/T, determining Po and VI by

$$\frac{T {c}_{max}^{*}}{{T}^{*}}$$

where Po is power of the photovoltaic plates and VI is power of the batteries, and determining the number of the photovoltaic plates and the batteries by Po and VI.

### BACKGROUND OF THE INVENTION

1. Field of the Invention

The invention relates to a sizing method for a stand-alone photovoltaic system.

2. Description of the Related Art

Photovoltaic (PV) systems have been a promising energy alternative in the world for decades. The high cost of implementation makes the sizing of a photovoltaic (PV) system important. Although the results derived from the traditional sizing curve methods are satisfactory in the normal cases, they cannot handle the extreme climate events and may fail in such situation. Furthermore, the sizing curve method involves the definition of Loss of Load Probability (LLP, the ratio between the estimated energy deficit and the energy demand over the total operation time of the installation) and the multiple simulations in terms of both LLP and the real data or synthetic time series obeying the average characteristics of the observed values. Thus, the sizing curve method can only provide a line of solutions by a given reliability, and one of them has to be chosen by experience.

### BRIEF SUMMARY OF THE INVENTION

To cope with the extremes, the invention provides a sizing method for a stand-alone photovoltaic system which includes photovoltaic plates and batteries. The sizing method in accordance with an exemplary embodiment of the invention includes steps of obtaining climate data in a site during a period of time, calculating Tcₘₐₓ/T by using the climate data where Tcₘₐₓ is maximal cycle time and T is battery charging time, identifying Tc*ₘₐₓ/T* where

$$\frac{{Tc}_{max}^{*}}{{T}^{*}}$$

is a minimal value of Tc_{max c}/T, determining Po and VI by

$$\frac{{Tc}_{max}^{*}}{{T}^{*}}$$

where Po is power of the photovoltaic plates and VI is power of the batteries, and determining the number of the photovoltaic plates and the batteries by Po and VI.

In another exemplary embodiment, Po is determined by

$$Po = Lo ( 1 + \frac{1}{R T E} ( \frac{T {c}_{max}^{*}}{{T}^{*}} - 1 ) )$$

where Lo is power of a load applied to the stand-alone photovoltaic system and RTE is round trip efficiency of the batteries. VI is determined by VI=Po−Lo.

In yet another exemplary embodiment, VI is determined by

$$VI = \frac{Lo}{R T E} ( \frac{T {c}_{max}^{*}}{{T}^{*}} - 1 )$$

where Lo is power of a load applied to the stand-alone photovoltaic system and RTE is round trip efficiency of the batteries. Po is determined by Po=Lo+VI.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 illustrates the concept of a climate cycle;

FIG. 2 depicts an example of the climate cycles of one year for Daytona Beach;

FIG. 3 depicts the relationship between Tcₘₐₓ/T and T for Daytona Beach;

FIG. 4 is a flowchart of sizing a stand-alone photovoltaic system in accordance with the invention;

FIG. 5 depicts the examples of H_{ξ,0,1} for ξ=0.75 (Fréchet), 0 (Gumbel) and −0.75 (Weibull);

FIG. 6 is a flowchart of evaluation of reliability of the sizing method for a stand-alone photovoltaic system in accordance with the invention;

FIG. 7 depicts the block extremes of Daytona Beach in thirty years (1961-1990);

FIG. 8 illustrates the sample distribution and the corresponding fitted GEVD by using the block extremes of FIG. 7; and

FIG. 9 depicts the climate cycles of fifteen years (1991-2005) for Daytona Beach.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a sizing method for a stand-alone photovoltaic (PV) system which includes a plurality of photovoltaic plates and batteries. The photovoltaic plates are arranged into an array. The sizing method is developed on base of the following assumptions: The daily load on the PV system is constant. The batteries are full at the beginning. The batteries are only charged by the PV system at day. The load is supplied in part by the PV system at day and totally by the batteries at night.

Supposing the batteries are charged fully by T hours and e₁ is the peak solar hour (PSH) at the jth day, let cᵢ={sᵢe₍ᵢ₋₁₎_{_{R′}}, e₁_{ᵢ}, eᵢ_{₂}, . . . , eᵢ_{_{R}}₋₁, (1−sᵢ₊₁)eᵢ_{_{R}}} be the ith climate cycle across R days for the specific site if and only if

$${\hat{\sum }}_{{e}_{j} ∈ {c}_{i}} {e}_{j} ≡ {s}_{i} {e}_{{( i - 1 )}_{{R}^{′}}} + {\sum }_{k = {i}_{1}}^{{i}_{R} - 1} {e}_{k} + ( 1 - {s}_{i + 1} ) {e}_{iR} = T for 1 \leq i \leq Q , \qquad ( 1 )$$

where there are totally Q cycles, 0≦sᵢ≦1 the percentage of the PSH at the last day of the previous cycle cᵢ₋₁ (across R′ days), and s₁=0.

A symbol

$$\hat{\sum }$$

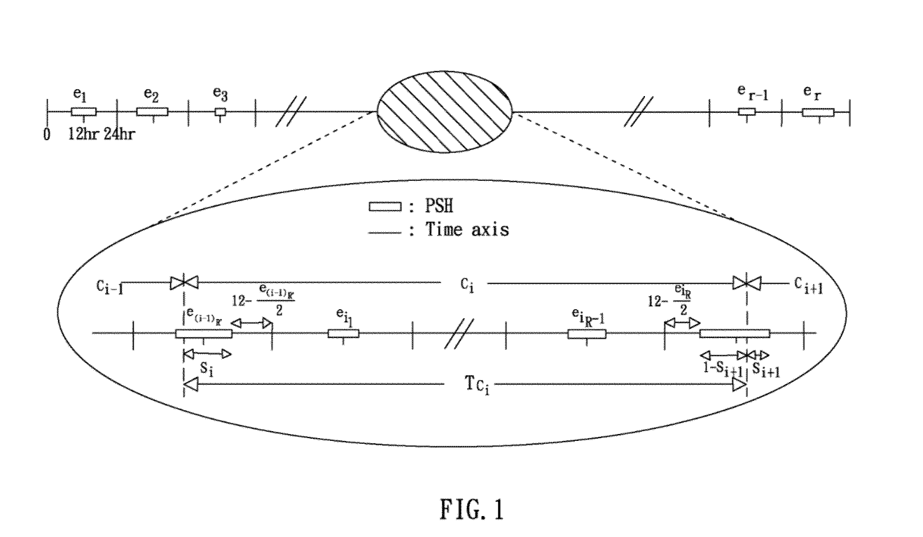

is defined to do the summation above. FIG. 1 illustrates the concept of a climate cycle c₁. The daily PHS is placed at the middle of each day. Hence, a climate cycle cᵢ may start from the sᵢ percentage of the PSH at the last day of the previous cycle cᵢ₋₁ and end at the (1−sᵢ₊₁) percentage of the PSH at the last day of this cycle. Let Tcᵢ be the cycle time (i.e., the discharge time) of cycle cᵢ, then it is expressed as

$${\hat{Σ}}_{{c}_{i}} 24 ≡ {Tc}_{i} = \{ \begin{matrix}\begin{matrix}{s}_{i} {e}_{( i - 1 ) {R}^{′}} + 12 - \frac{{e}_{{( i - 1 )}_{{R}^{′}}}}{2} + 24 ( R - 1 ) + \\ ( 1 - {s}_{i + 1} ) {e}_{iR} + 12 - \frac{{e}_{iR}}{2} ,\end{matrix} & 1 < i \leq Q \\ 24 ( R - 1 ) + ( 1 - {s}_{i + 1} ) {e}_{iR} + 12 - \frac{{e}_{iR}}{2} , & i = 1.\end{matrix} \qquad ( 2 )$$

In unit of a day, it is denoted as

$${Td}_{i} = \{ \begin{matrix}{e}_{( i - 1 ) {R}^{′}} ( {s}_{i} - \frac{1}{2} ) / 24 + R + {e}_{iR} ( \frac{1}{2} - {s}_{i + 1} ) / 24 , & 1 < i \leq Q , \\ R - 1 / 2 + {e}_{iR} ( 1 / 2 - {s}_{i + 1} ) / 24 , & i = 1.\end{matrix} \qquad ( 3 )$$

Let D(eᵢ) be the date of eᵢ and Dₘₐₓ be the starting date of the maximal cycle. An algorithm to create the block climate cycles for T is provided as follows.

Step 1. k=1, C=0, Td=0, SD=D(e₁) and Tdₘₐₓ=0.//SD is a variable for keeping the starting date of each cycle. C is the cumulative PSH for each cycle.

Step 2. For 1≦i≦r do//Assume there are r days of data.

Step 3. If floor ((C+eᵢ)/T)≧1, then Begin

Step 4. For 1≦j≦floor ((C+eᵢ)/T) do

Step 5. If j=1, then Td=Td+(T−C+12−eᵢ/2)/24, else Td=T/24.

Step 6. Output ‘Cycle No.’, k, ‘Starting Date:’, SD, ‘Cycle Length:’, Td.

Step 7. If Td>Tdₘₐₓ, then Tdₘₐₓ=Td and Dₘₐₓ=SD.

Step 8. k=k+1. Endfor.

Step 9. C=eᵢ−T_{*}j+C, Td=(C+12−eᵢ/2)/24, SD=D(eᵢ).

Step 10. If the year of SD≠the year of Dₘₐₓ then Begin

Step 11. Output ‘Yearly Max. Cycle Starting Date:’, Dₘₐₓ, ‘Cycle Length:’, Tdₘₐₓ.

Step 12. Tdₘₐₓ=Td and Dₘₐₓ=SD. End.

Step 13. End, else Td=Td+1, C=C+eᵢ. Endfor.

Step 14. k=k+C/T.

Step 15. Output ‘Cycle No.’, k, ‘Starting Date:’, SD, ‘Cycle Length:’, Td.

Step 16. Output ‘Yearly Max. Cycle Starting Date:’, Dₘₐₓ, ‘Cycle Length:’, Tdₘₐₓ.

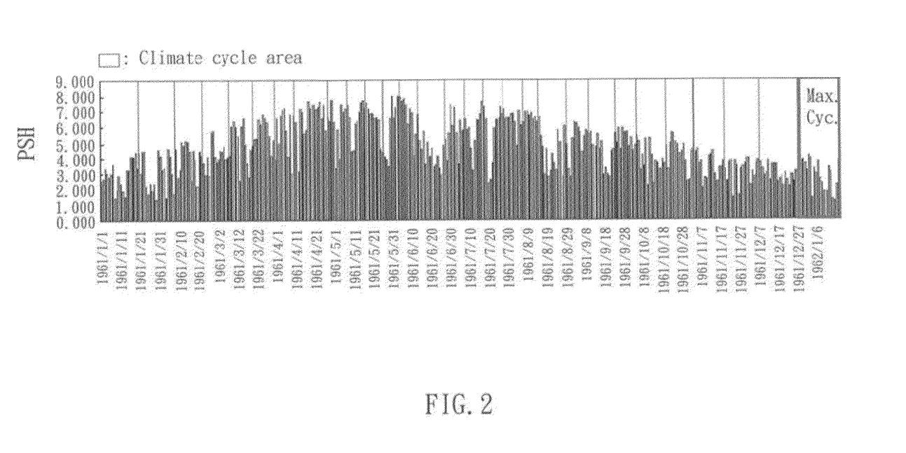

An example of the climate cycles (T=58.7 hours) of one year created by the above algorithm for Daytona Beach is illustrated in FIG. 2. The maximal climate cycle of that year started at 1961/12/24 and continued for 20.0436 days.

In a cycle cᵢ, the generated energy equals the consumed energy. Let P₀ denote the power of the PV array, L₀ denote the power of the load, and RTE be the round trip efficiency for a battery, then the balance equation is

$${\hat{Σ}}_{{e}_{j} ∈ {c}_{i}} {e}_{j} {P}_{0} = {\hat{Σ}}_{{e}_{j} ∈ {c}_{i}} {e}_{j} {L}_{0} + {\hat{Σ}}_{{e}_{j} ∈ {c}_{i}} ( 24 - {e}_{j} ) \frac{{L}_{0}}{RTE} . \qquad ( 4 )$$

Similarly, the energy supplied by the batteries in that cycle equals the energy stored at the batteries in the same cycle. Let VI be the power of the batteries. The second balance equation is

$${\hat{Σ}}_{{e}_{j} ∈ {c}_{i}} ( 24 - {e}_{j} ) \frac{{L}_{0}}{RTE} = {\hat{Σ}}_{{e}_{j} ∈ {c}_{i}} {e}_{j} VI . \qquad ( 5 )$$

Note that the different application may cause different balance equations. The following equations (6), (7), and (8) can be derived from equations (4) and (5).

$${P}_{0} = {L}_{0} ( 1 + \frac{1}{RTE} ( \frac{{Tc}_{i}}{T} - 1 ) ) \qquad ( 6 )$$

Equation (6) is proved as follows.

$${\hat{Σ}}_{{e}_{j} ∈ {c}_{i}} {e}_{j} {P}_{0} = {\hat{Σ}}_{{e}_{j} ∈ {c}_{i}} {e}_{j} {L}_{0} + {\hat{Σ}}_{{e}_{j} ∈ {c}_{i}} ( 24 - {e}_{j} ) \frac{{L}_{0}}{RTE} . \\ \begin{matrix}⇒ {P}_{0} = {L}_{0} + \frac{{\hat{Σ}}_{{e}_{j} ∈ {c}_{i}} ( 24 - {e}_{j} )}{{\hat{Σ}}_{{e}_{j} ∈ {c}_{i}} {e}_{j}} \frac{{L}_{0}}{RTE} \\ = {L}_{0} + ( \frac{{Tc}_{i}}{T} - 1 ) \frac{{L}_{0}}{RTE} \\ = {L}_{0} ( 1 + \frac{1}{RTE} ( \frac{{Tc}_{i}}{T} - 1 ) )\end{matrix} \\ VI = \frac{{L}_{0}}{RTE} ( \frac{{Tc}_{i}}{T} - 1 ) \qquad ( 7 )$$

Equation (7) is proved as follows.

$${\hat{Σ}}_{{e}_{j} ∈ {c}_{i}} ( 24 - {e}_{j} ) \frac{{L}_{0}}{RTE} = {\hat{Σ}}_{{e}_{j} ∈ {c}_{i}} {e}_{j} {VI}_{i} \\ ⇒ \frac{{L}_{0}}{RTE} \frac{{\hat{Σ}}_{{e}_{j} ∈ {c}_{i}} ( 24 - {e}_{j} )}{{\hat{Σ}}_{{e}_{j} ∈ {c}_{i}} {e}_{j}} = VI \\ ⇒ \frac{{L}_{0}}{RTE} \frac{{\hat{Σ}}_{{e}_{j} ∈ {c}_{i}} 24 - {\hat{Σ}}_{{e}_{j} ∈ {c}_{i}} {e}_{j}}{{\hat{Σ}}_{{e}_{j} ∈ {c}_{i}} {e}_{j}} = VI \\ ⇒ \frac{{L}_{0}}{RTE} ( \frac{{\hat{Σ}}_{{e}_{j} ∈ {c}_{i}} 24}{{\hat{Σ}}_{{e}_{j} ∈ {c}_{i}} {e}_{j}} - 1 ) = VI \\ ⇒ VI = \frac{{L}_{0}}{RTE} ( \frac{{Tc}_{i}}{T} - 1 )$$

When both equations (6) and (7) are considered, the power for the PV array, the load, and the batteries have the following relationship at that cycle:

P₀=L₀+VI (8)

Equation (8) is proved as follows.

$${\hat{Σ}}_{{e}_{j} ∈ {c}_{i}} {e}_{j} {P}_{0} = {\hat{Σ}}_{{e}_{j} ∈ {c}_{i}} {e}_{j} {L}_{0} + {\hat{Σ}}_{{e}_{j} ∈ {c}_{i}} ( 24 - {e}_{j} ) \frac{{L}_{0}}{RTE} . \\ ⇒ ( {P}_{0} - {L}_{0} ) {\hat{Σ}}_{{e}_{j} ∈ {c}_{i}} {e}_{j} = \frac{{L}_{0}}{RTE} {\hat{Σ}}_{{e}_{j} ∈ {c}_{i}} ( 24 - {e}_{j} ) . \\ ⇒ ( {P}_{0} - {L}_{0} ) {\hat{Σ}}_{{e}_{j} ∈ {c}_{i}} {e}_{j} = VI {\hat{ Σ}}_{{e}_{j} ∈ {c}_{i}} {e}_{j} . \\ ⇒ ( {P}_{0} - {L}_{0} ) = VI . \\ ⇒ {P}_{0} = {L}_{0} + VI .$$

Tcᵢ/T is named the discharge/charge time ratio for cycle i and may be thought as a weather indicator for that cycle. When the ratio is large, the climate is most likely overcast. Conversely, the sky is most likely clear. Equations (6) and (7) make the connection between the weather condition and the power of the PV array and the batteries.

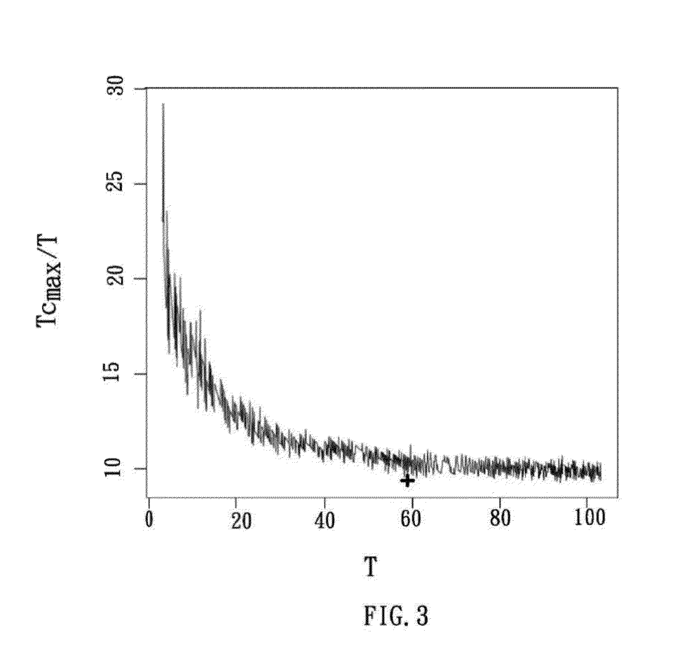

For an adequate design of a PV system, the energy balance occurs in a chosen climate cycle such that the total energy deficit for the whole period is minimal. The strategy is thus: if the energy balance is occurred at the maximal cycle, then the energy deficit is minimized. Let max Tcₘₐₓ≡max{Tcᵢ|1≦i≦Q}. How to choose a suitable charging time T and get the corresponding Tcₘₐₓ depends on the given weather condition. Empirical study shows that the relationship between TCₘₐₓ/T and T is not linear. Actually it is a nearly convex function. FIG. 3 illustrates the relationship between TCₘₐₓ/T and T for Daytona Beach. If the charging time T gets shorter, then the ratio becomes more versatile. However, when the charging time gets longer than the turn, the ratio becomes more and more stable. This is due to the average effect of a long period. This effect will veil the extremes in that period. Therefore, before fully sticking into the effect, a best choice would be the lowest point at the turn (i.e., the point of “+” in FIG. 3) and the corresponding Tcₘₐₓ/T is denoted as Tc*ₘₐₓ/T* hereinafter. Then, equations (6), (7) and (8) give the way of determining the size of the PV array and the number of batteries.

Let C₀ be the capacity (Ah) of a battery and I₀ be the maximal charging current. In practice, a battery bank normally includes m modules of batteries connected in parallel to fit the current requirement. Each module has l batteries connected serially to fit the voltage requirement. Due to the fact that a minimal charging time is required, T* has a implicit lower bound as follows.

$${T}^{*} \geq \frac{{lC}_{0}}{{I}_{0}} \qquad ( 9 )$$

However, I₀ is proportional to the parallel modules of the PV array. A justification of T* against IC₀/I₀ should be made after the sizing task done. From equation (6), the size of PV array is thus

$${P}_{0} = {L}_{0} ( 1 + \frac{1}{RTE} ( \frac{{Tc}_{max}^{*}}{{T}^{*}} - 1 ) ) . \qquad ( 10 )$$

Also, the size of the batteries can be obtained from the following equation:

$$VI = \frac{{L}_{0}}{RTE} ( \frac{{Tc}_{max}^{*}}{{T}^{*}} - 1 ) . \qquad ( 11 )$$

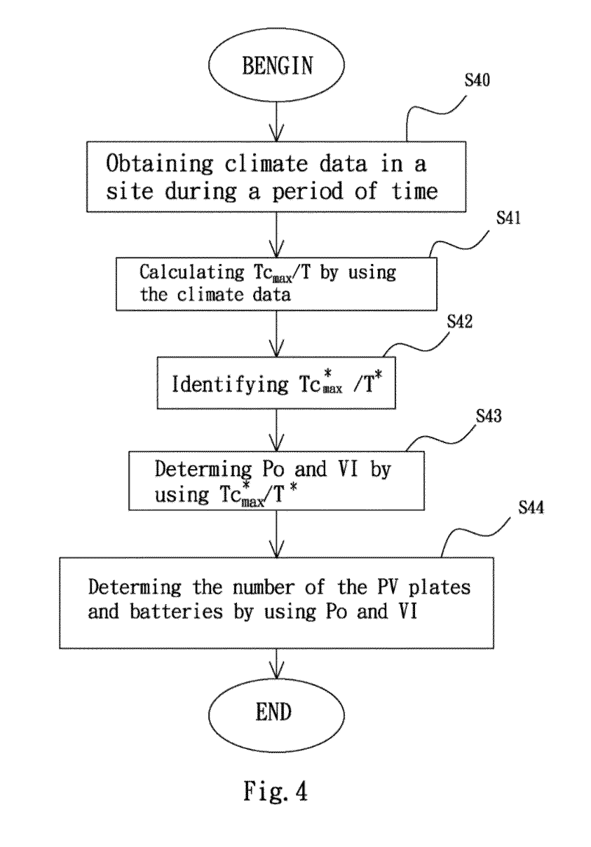

Based on the descriptions above, the sizing method for a stand-alone photovoltaic system in accordance with the invention is shown in FIG. 4. In step S40, climate data in a site during a period of time is obtained. In step S41, Tcₘₐₓ/T is calculated by using the obtained climate data, where Tcₘₐₓ is the maximal cycle time and T is battery charging time. In step S42, Tc*ₘₐₓ/T* is identified, where Tc*ₘₐₓ/T* is the minimal value of Tcₘₐₓ/T. In step S43, Po and VI are determined by using Tc*ₘₐₓ/T*, wherein Po is power of the photovoltaic plates, VI is power of the batteries, and Po and VI can be determined by equations (10), (11), and (8). Specifically, VI can be determined by equations (11) or (8) if Po is obtained from equation (10). Alternatively, Po can be determined by equations (10) or and (8) if VI is obtained from equation (11). In step S44, the number of the photovoltaic plates and the batteries is determined by using Po and VI.

Equation (8) gives the conversion between equations (6) and (7). In practice, the battery and the PV plate cannot be divided. Equations (6) and (7) implicitly indicate a tolerance for the weather conditions. This can be recognized as a “safety factor” for the extra loss. An enumeration can be done for both the number of batteries and the number of PV plates around these values to get the different LPPₓ. These are the alternative solutions for different reliabilities.

In the invention, the extreme value theory (EVT) is used for the evaluation of LPPₓ under observed data. Because of the maximal climate cycle employed, LPPₓ of the sizing results will be promised. Given the observations X₁, X₂, . . . , X₃₀ iid with the distribution function Pr (X₁≦x)=1−e^{-x/15}, x≧0, the random variable X_{1,n} receives attentions,

where X_{1,n}=Mₙ=max (X₁, X₂, . . . Xₙ),

or the full set of order statistics

X_{n,n}≦X_{n-1,n}≦ . . . ≦X_{1,n}.

Therefore,

Pr(M₃₀>x)=1−(Pr(X₁≦x)³⁰=1−(1−e^{-x/15}))³⁰.

From this, Pr(M₃₀>60)=0.4256770 is obtained.

Now, consider the following equation:

$$Pr ( \frac{{M}_{n}}{15} - log n \leq x ) = Pr ( {M}_{n} \leq 15 ( x + log n ) ) = {( 1 - \frac{{e}^{- x}}{n} )}^{n} ,$$

So that

$${lim}_{n \to ∞} Pr ( \frac{{M}_{n}}{15} - log n \leq x ) = {e}^{- {e}^{- x}} = Λ ( x ) ( Gumbel distribution ) .$$

However, the distribution function of X₁ is usually unknown in advance. To overcome this issue, the extreme value theory gives the following important results:

It is supposed that X₁, X₂, . . . , Xₙ are iid random variables. If there are constants aₙε [symbol] , bₙ>0 and some non-degenerate limit distribution H such that

$${lim}_{n \to ∞} Pr ( \frac{{M}_{n} - {a}_{n}}{{b}_{n}} \leq x ) = H ( x ) ,$$

then H is one of the following extreme value distributions:

$$Fréchet \text{:} {Φ}_{α} = \{ \begin{matrix}0 , & x \leq 0 \\ {e}^{- {x}^{- α}} , & x > 0\end{matrix} α > 0 , \\ Weibull \text{:} {Ψ}_{α} ( x ) = \{ \begin{matrix}{e}^{- {( - x )}^{- α}} , & x \leq 0 \\ 0 , & x > 0\end{matrix} α > 0 \\ Gumbel \text{:} {Λ}_{α} ( x ) = {e}^{- {e}^{- x}} , x ∈ ℜ$$

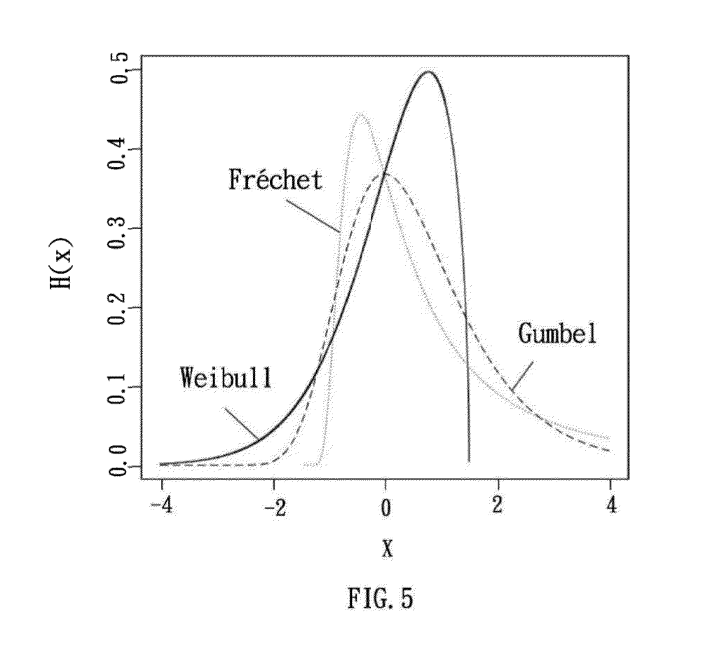

A more general form named the generalized extreme value distribution (GEVD) of the three distributions can be expressed as

$${H}_{ξ , μ , σ} ( \frac{x - μ}{σ} ) = \{ \begin{matrix}{e}^{- {( 1 + ξ \frac{x - μ}{σ} )}^{- \frac{1}{ξ}} ,} & ξ \neq 0 , \\ {e}^{- {e}^{\frac{x - μ}{σ}}} , & ξ = 0 ,\end{matrix} \qquad ( 12 )$$

where ξ is the tail index, μ is the position paramenter, and σ is the scaling parameter. Examples for the three distributions are shown in FIG. 5.

From the above description, it is understood that the tail of any iid random variable with unknown distribution will asymptotic converge to the GEVD. This is a very important result to precisely estimate LPPₓ mathematically.

LPPₓ (the loss of power probability for x) is formally defined as:

$${LPP}_{X} ≡ Pr ( {X}_{1 , n} > x ) = 1 - {H}_{ξ , μ , σ} ( \frac{x - μ}{σ} ) . \qquad ( 13 )$$

An energy deficit occurs when the length of the current climate cycle is longer than the given length x. LPPₓ provides the upper bound probability for the occurrence of energy deficit.

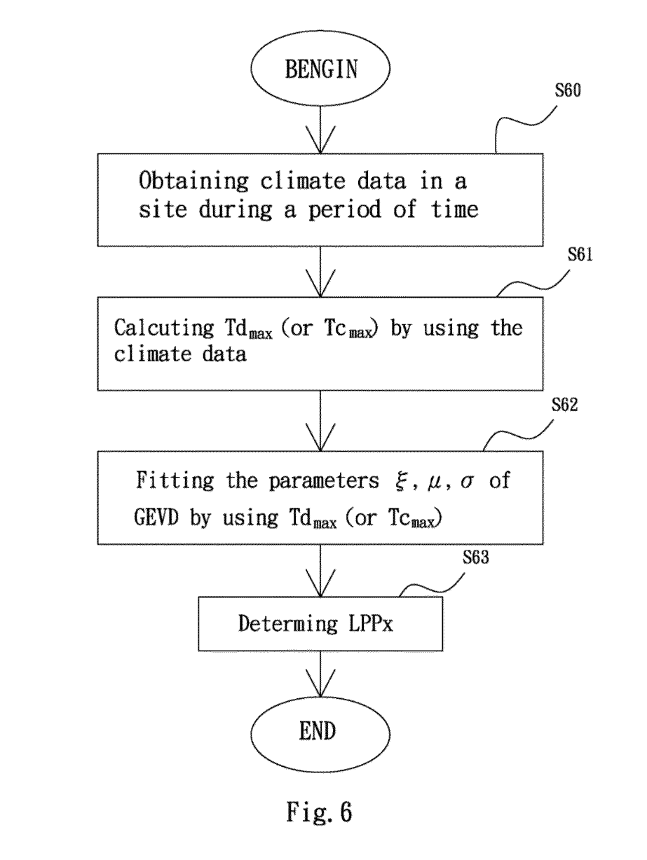

The evaluation of reliability of the sizing method for a stand-alone photovoltaic system in accordance with the invention is shown in FIG. 6. In step S60, climate data in a site during a period of time is obtained. In step S61, the maximal cycle time Tdₘₐₓ (or Tcₘₐₓ) is calculated by using the climate data. In step S62, the parameters ξ, μ and σ of GEVD are fitted in according with the obtained maximal cycle time Tdₘₐₓ (or Tcₘₐₓ). In the invention, the maximal likelihood estimation is employed to fit the parameters ξ, μ and σ. The log-likelihood function is

$$\begin{matrix} {L}_{ξ , μ , σ} ( x ) = {\sum }_{i} log ( {h}_{ξ , μ , σ} ( {x}_{i} ) ) , \\ where & ( 14 ) \\ {h}_{ξ , μ , σ} ( x ) = \{ \begin{matrix}\frac{1}{σ} {( 1 + ξ \frac{x - μ}{σ} )}^{- 1 / ξ - 1} exp ( - {( 1 + ξ \frac{x - μ}{σ} )}^{- 1 / ξ} ) , ξ \neq 0 , 1 + ξ \frac{x - μ}{σ} > 0. \\ \frac{1}{σ} exp ( - \frac{x - μ}{σ} ) exp ( - exp ( - \frac{x - μ}{σ} ) ) , ξ = 0.\end{matrix} & ( 15 )\end{matrix}$$

In step S63, LPPₓ (the loss of power probability for x) is determined by equations (12) and (13).

### Numerical Examples

Two sets of the solar radiation data near Daytona Beach, Fla., USA are illustrated: one is for the in-sample test, the 30 years of the measured daily solar radiation between 1961 and 1990; the other is for the out-of-sample test, the 15 years of the measured daily solar radiation between 1991 and 2005. Both data are obtained from the Renewable Resource Data Center of the National Renewable Energy Laboratory, USA. Assume there is a constant daily load of 4 kWh (48V) uniformly distributed in a day to be powered by the PV system (205W, 48V for one plate) with batteries regulated, where 205W is the average power of the PV plates during PSH. Then, each module of the battery bank needs 4 batteries (lead-acid type, 12V, 100Ah) cascaded. The RTE of the battery is 0.9.

At first, the empirical analysis of the ratio Tcₘₐₓ/T vs. T is conducted. FIG. 3 illustrates this relationship. A “+” symbol denotes that the minimal ratio 9.42851 is at 58.7 h (=T*) of the turn in this analysis. The corresponding length of maximal climate cycle is 23.06058 days (Tdₘₐₓ*). From equation (10),

$$\begin{matrix}{P}_{0} = {L}_{0} ( 1 + \frac{1}{RTE} ( \frac{{Tc}_{max}^{*}}{{T}^{*}} - 1 ) ) = \frac{4000}{24} ( 1 + \frac{1}{0.9} ( 9.42851 - 1 ) ) \\ = 1727.502 ( W ) = 8.43 plates .\end{matrix}$$

Thus, at least eight PV plates are required. The alternatives for the size of PV plates may be 8, 9, 10, 11, etc. The size of batteries is determined by equation (8) or (11).

$$VI = {P}_{0} - {L}_{0} = 1727.502 - \frac{4000}{24} = 1560.835 ( W ) = 3.25 modules .$$

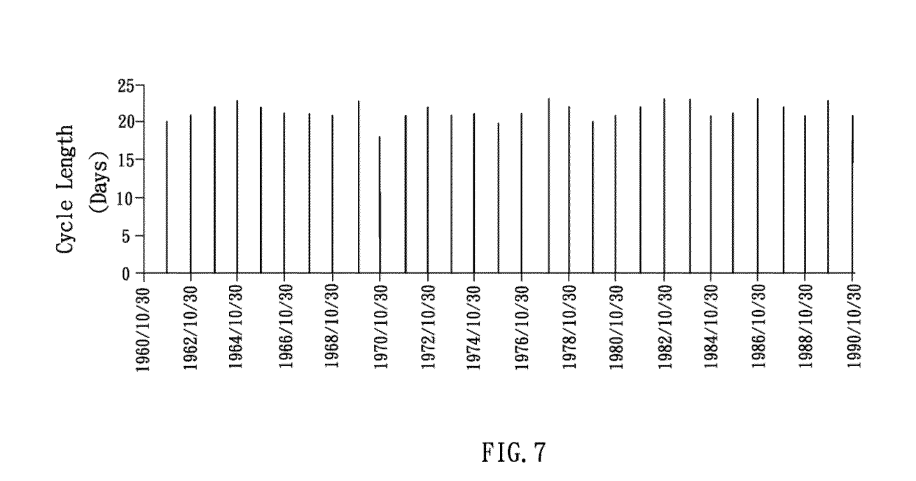

Under 10 h rate (C/10), the module alternatives for the battery bank are: m=4 or m=5, since five modules of batteries can cover the electric current generated by twelve PV plates under C/10. The decision that which pair of combination are the best is dependent on the analysis of LPPₓ. To calculate LPPₓ, the parameters of GEVD have to be estimated. The block extremes of the 30 years are illustrated in FIG. 7.

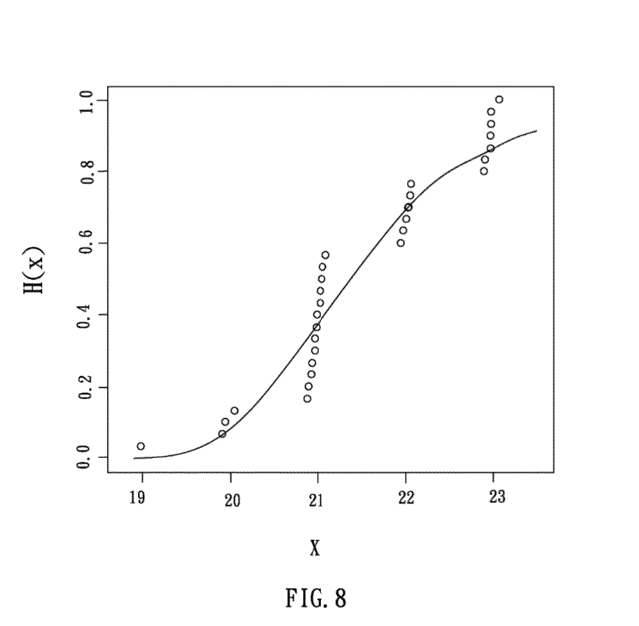

As described, the maximal likelihood estimation is employed to fit the parameters ξ, μ and ρ. Thus, ξ=0.000001, σ=1.048 and μ=20.947. FIG. 8 illustrates the sample distribution and the corresponding fitted GEVD.

Now, LPPx can be calculated for the sizing results. For example, LPPx for four modules of batteries and eight PV plates is calculated by:

$${Tc}_{max} = 58.7 ( 0.9 ( 8 \cdot 205 / ( 4000 / 24 ) - 1 ) + 1 ) = 525.7172 ( h ) = 21.90488 ( days ) , \\ {LPP}_{21.90488} = 1 - {H}_{0.000001 , 20.947 , 1.048} ( \frac{22.14947 - 20.947}{1.048} ) = 0.3303 ,$$

which means that the probability of the block maximal cycle length greater than 21.90488 days in the period of 30 years is 0.3303. Table 1 gives the results of the other alternatives. It is understood that the proper combination of PV plates and batteries can be chosen according to the specific requirement of LPPx.

TABLE 1

| | | the number of PV plates | | | |
|---|---|---|---|---|---|
| LPPx | | 8 | 9 | 10 | 11 |
| battery | 4 | 0.3303 | 0.02981 | 0.002283 | 0.001439 |
| modules | 5 | 0.3303 | 0.02981 | 0.002283 | 0.0001726 |

On the other hand, if it is desired to determine the size of a PV system by a given LPP_{\hat{x}}=p, the following quantile equation can be conducted.

$$\hat{x} = \{ \begin{matrix}μ - \frac{σ}{ξ} ( 1 - {( - log ( 1 - p ) )}^{- ξ} , & ξ \neq 0. \\ μ - σ log ( - log ( 1 - p ) ) , & ξ = 0.\end{matrix} \qquad ( 16 )$$

For instance, let LPP_{\hat{x}}=0.001, the corresponding \hat{x} calculated is 28.18583 days. Then, the required number of PV plates and the module of batteries are

$${P}_{0} = \frac{4000}{24} ( 1 + \frac{1}{0.9} ( 28.18583 \cdot 24 / 58.7 - 1 ) ) = 2115.559 . \\ VI = {P}_{0} - {L}_{0} = 2115.559 - \frac{4000}{24} = 1948.892 .$$

Eleven plates for the PV array, and five modules for the battery bank are obtained under the requirement of LPP_{\hat{x}}=0.001 (see Table 1 for this entry).

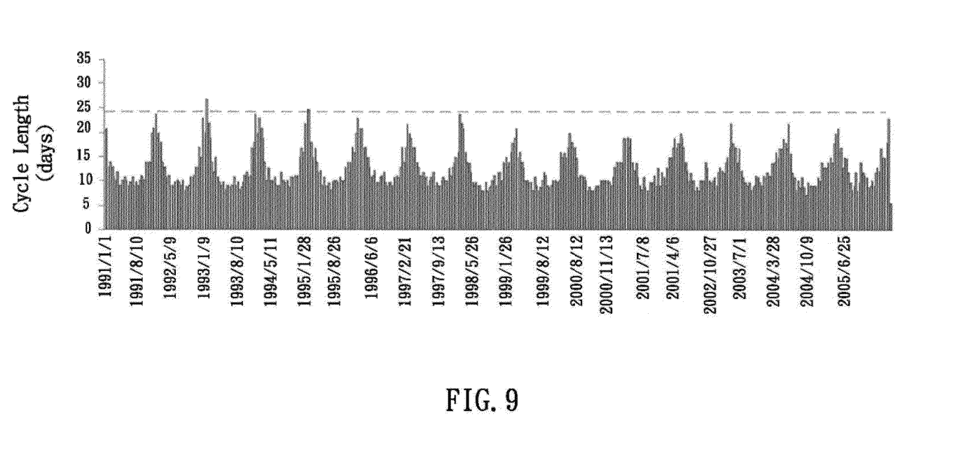

To verify the results of the proposed approach is consistent to the future, an out-of-sample test is necessary to perform. The same charging time (58.7 h) is employed for the derivation of climate cycle statistics for the period between 1991 and 2005. FIG. 9 displays the climate cycles in the period of 15 years. The dashed line in FIG. 9 denotes the maximal tolerable cycle (24.6124 days) for this system. It was shown that only three climate cycles exceeds. They were 26.9824 days starting at 1992/12/13, 24.9963 days starting at 1994/11/21, and 24.9883 days starting at 1994/12/16. The probabilities for the three extreme events were estimated as 0.003149, 0.02077, and 0.02093 respectively in the period of moving 30 years. These are the evidences for climate changing because the maximal cycle becomes larger and the number of extremes increased, which cannot be observed before. In the invention, however, how many years the three extremes would happen again can even be estimated by GEVD. This is done by the following formula:

$$K = \frac{1}{p} \qquad ( 17 )$$

where K (years) are the interval of event occurrence, p is the probability for that event. Hence, the three events occur again at the next 317.5611, 48.146 and 47.7783 years respectively.

The invention provides a sizing method for a stand-alone photovoltaic system, which can fast provide the specific recommendations for both the size of PV array and the number of batteries. The climate cycle creation is performed in terms of the battery charging time under the worst case. This is different from the conventional way of climate cycle identification, which was basically by experiences. On the construction of sizing formulas, the energy balance among the energy generated by the PV array, the energy consumed by the load and the energy stored in the batteries is cycle-based which differs from the long-term based energy balance employed by the sizing curve method. A cycle is chosen such that the total energy deficit for the whole period is minimal. After that, the statistic upper bound reliability LPPx is computed in terms of block maxima. The in-sample test and the out-of-sample test show that the invention can easily obtain good results.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A sizing method for a stand-alone photovoltaic system which comprises photovoltaic plates and batteries, comprising:
obtaining climate data in a site during a period of time;
calculating Tcₘₐₓ/T by using the climate data, where Tcₘₐₓ is maximal cycle time, and T is battery charging time;
identifying Tc*ₘₐₓ/T*, where
$$\frac{{Tc}_{max}^{*}}{{T}^{*}}$$
is a minimal value of Tcₘₐₓ/T;
determining Po and VI by
$$\frac{{Tc}_{max}^{*}}{{T}^{*}} ,$$
where Po is power of the photovoltaic plates and VI is power of the batteries; and
determining number of the photovoltaic plates and the batteries by Po and VI.

2. The sizing method as claimed in claim 1, wherein Po is determined by
$$Po = Lo ( 1 + \frac{1}{RTE} ( \frac{{Tc}_{max}^{*}}{{T}^{*}} - 1 ) )$$
where Lo is power of a load applied to the stand-alone photovoltaic system, and RTE is round trip efficiency of the batteries.

3. The sizing method as claimed in claim 2, wherein VI is determined by VI=Po−Lo.

4. The sizing method as claimed in claim 1, wherein VI is determined by
$$VI = \frac{Lo}{RTE} ( \frac{{Tc}_{max}^{*}}{{T}^{*}} - 1 )$$
where Lo is power of a load applied to the stand-alone photovoltaic system, and RTE is round trip efficiency of the batteries.

5. The sizing method as claimed in claim 4, wherein Po is determined by Po=Lo+VI.
